(19) United States
(12) Patent Application Publication
(10) Pub. No.: US 2025/0282272 A1
(43) Pub. Date: Sep. 11, 2025

(54) TRUCK BED MOUNTED LIFTING DEVICE

(71) Applicant: Ford Global Technologies, LLC, Dearborn, MI (US)

(72) Inventor: Cliff Standifer, Canton, MI (US)

(21) Appl. No.: 18/597,026

(22) Filed: Mar. 6, 2024

(51) Int. Cl. B60P 1/54

(52) U.S. Cl. CPC B60P 1/5461

(57) ABSTRACT

A hoist assembly for a vehicle cargo bed may include a base portion operably coupled to a subframe of the vehicle in the vehicle cargo bed, a first pivot arm operably coupled to the base portion proximate a first end of the first pivot arm to pivot relative to the base portion between a deployed state and a storage state, a second pivot arm operably coupled to a second end the first pivot arm to pivot relative to the second end of the first pivot arm when transitioning between the deployed state and the storage state, and a carriage assembly operably coupling the first pivot arm to the base portion and enabling the first pivot arm to move relative to the base portion along a longitudinal axis of the base portion while the first pivot arm is in the deployed state.

### TECHNICAL FIELD

Example embodiments generally relate to vehicle accessories and, more particularly, relate to a lifting device mounted in the bed of a truck.

### BACKGROUND

Pickup trucks, which are often considered to be light duty trucks, are some of the most popular vehicles on the road. These trucks, and their related medium and heavy duty cousins, are popular at least in part because the open beds that they commonly possess provide a great deal of flexibility for operators with respect to payloads that can be carried. That said, the addition of accessories, as either a dealer option or an aftermarket add on, gives operators even more flexibility to customize or expand the capabilities of their vehicles, and further fuel the popularity of these vehicles.

One such accessory may be a truck bed hoist. Since the hoist must necessarily take up space within the truck bed, the balance between size and capability may be difficult to achieve. Example embodiments aim to provide a highly capable truck bed hoist that still minimizes its footprint within the truck bed.

### BRIEF SUMMARY OF SOME EXAMPLES

In accordance with an example embodiment, a hoist assembly for a vehicle cargo bed may be provided. The hoist assembly may include a base portion operably coupled to a subframe of the vehicle in the vehicle cargo bed, a first pivot arm operably coupled to the base portion proximate a first end of the first pivot arm to pivot relative to the base portion between a deployed state and a storage state, a second pivot arm operably coupled to a second end the first pivot arm to pivot relative to the second end of the first pivot arm when transitioning between the deployed state and the storage state, and a carriage assembly operably coupling the first pivot arm to the base portion and enabling the first pivot arm to move relative to the base portion along a longitudinal axis of the base portion while the first pivot arm is in the deployed state.

In another example embodiment, a hoist assembly for a vehicle cargo bed may be provided, and include a base portion operably coupled to a subframe of the vehicle in the vehicle cargo bed. The hoist assembly may also include a first pivot arm operably coupled to the base portion proximate a first end of the first pivot arm to pivot relative to the base portion between a deployed state and a storage state, and a second pivot arm operably coupled to a second end the first pivot arm to pivot relative to the second end of the first pivot arm when transitioning between the deployed state and the storage state. The first pivot arm may be extended along a deployment axis to be substantially perpendicular to the base portion in the deployed state and folded to be substantially parallel to the base portion in the storage state. The first pivot arm may also be both moveable in a direction perpendicular to the deployment axis and rotatable about the deployment axis in the deployed state.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a vehicle cargo bed with a hoist assembly in accordance with an example embodiment;

FIG. 2 illustrates a perspective view of the hoist assembly in isolation in accordance with an example embodiment;

FIG. 3 illustrates an exploded view of components of the hoist assembly in accordance with an example embodiment;

FIG. 4A illustrates a side view of a winch assembly in accordance with an example embodiment;

FIG. 4B illustrates a perspective view of the winch assembly of FIG. 4A in accordance with an example embodiment;

FIG. 5A illustrates a perspective view of a tower casing in accordance with an example embodiment;

FIG. 5B illustrates a cross section view of the tower casing in accordance with an example embodiment;

FIG. 6 illustrates deployment of a first pivot arm while transitioning toward a deployed state of the hoist assembly in accordance with an example embodiment;

FIG. 7 illustrates a cross section view of the hoist assembly after deployment of the first pivot arm while transitioning toward the deployed state of the hoist assembly in accordance with an example embodiment;

FIG. 8 illustrates locking of the first pivot arm upright while transitioning toward the deployed state of the hoist assembly in accordance with an example embodiment;

FIG. 9A illustrates deployment of a second pivot arm while transitioning toward the deployed state of the hoist assembly in accordance with an example embodiment;

FIG. 9B illustrates the second pivot arm being fully deployed while transitioning toward a deployed state of the hoist assembly in accordance with an example embodiment; and

FIG. 10 illustrates a perspective view of the hoist assembly in the deployed state in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may provide a truck bed hoist that is sized to take up a relatively small area within the truck bed, but still provides enhanced capability due at least in part to its rigid mounting to the chassis (e.g., frame or sub frame) of the vehicle (instead of merely being mounted to the floor of the bed). While maintaining a strong foundation due to its rigid mounting to the chassis, the truck bed hoist is foldable into a relatively small storage position, and extendable into a deployed position that allows both extension and rotation that give the truck bed hoist extensive reach and capability for moving objects to and within the truck bed from beyond an extended tail gate.

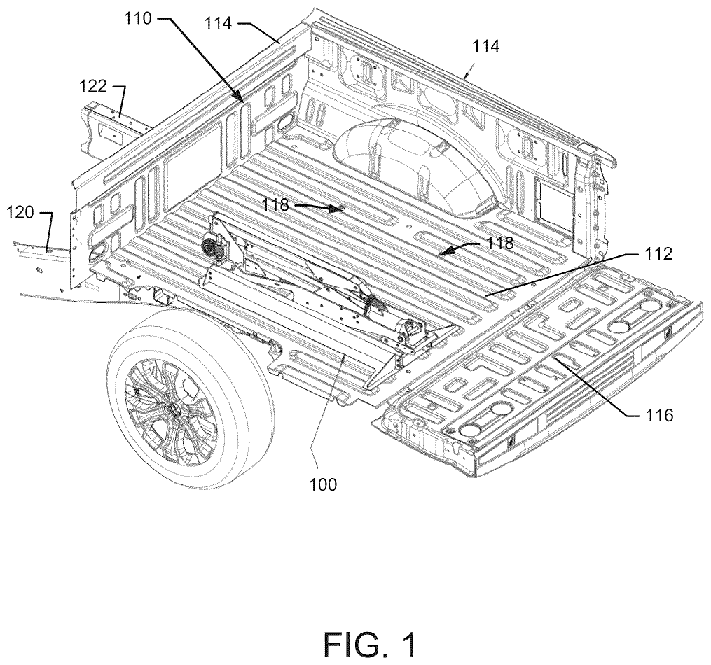

FIG. 1 illustrates a perspective view of a hoist assembly 100 in a storage state within a vehicle cargo bed 110. The vehicle cargo bed 110 may be defined by a floor 112, three sidewalls 114 (only two of which are shown in FIG. 1 to enhance visibility of the hoist assembly), and a tail gate 116. The tail gate 116 may be extended as shown in FIG. 1 and lie parallel with the floor 112 when extended. However, when the tail gate 116 is closed, the tail gate 116 essentially forms a fourth sidewall enclosing the vehicle cargo bed 110.

The vehicle may include a chassis formed from an assembly of frame members or subframe members. However, in some cases, the chassis may include a cast frame. In the example of FIG. 1, the chassis may include a first subframe member 120 and a second subframe member 122 that may extend substantially longitudinally along left and right sides of the vehicle, respectively. Unlike conventional truck bed hoists, which may be mounted to the floor 112 (if mounted at all), example embodiments may mount the hoist assembly 100 to one of the first subframe member 120 or the second subframe member 122 through floor openings 118 that are formed in the floor 112 and extend through the floor 112 to provide access for a fastener (e.g., a threaded fastener) to attach the hoist assembly 100 either directly or indirectly to the first subframe member 120 or the second subframe member 122. When such connection is direct, the threaded fastener may pass through a portion of the hoist assembly 100, and through the floor opening 118 to thread into a receptacle formed at the first subframe member 120 or the second subframe member 122. When such connection is indirect, a bracket may be attached to the first subframe member 120 and the second subframe member 122 proximate to each instance of the floor opening 118, and the threaded fastener may pass through the portion of the hoist assembly 100, and through the floor opening 118 to thread into the bracket attached to the first subframe member 120 or the second subframe member 122.

Notably, the first subframe member 120 and the second subframe member 122 extend along sides of the vehicle cargo bed 110 (and therefore parallel to and relatively close to the sidewalls 114 that are perpendicular to the tail gate 116 (when closed). The mounting of the hoist assembly 100 to the first and second subframe members 120 and 122 therefore by necessity places the hoist assembly 100 off to one side or the other of the vehicle cargo bed 110 thereby maximizing the available space alongside the hoist assembly 100 into which an object hoisted by the hoist assembly 100 can be located. The positioning of the hoist assembly 100 is therefore strategic both in terms of space efficiency and robust mounting. Moreover, as will be discussed in greater detail below, the structure and componentry employed in the hoist assembly 100 is further designed to maximize space efficiency and robust capability within the unique environment of the vehicle cargo bed 110 by enabling the hoist assembly 100 to remain fully assembled, but easily capable of transitioning between the storage state shown in FIG. 1 and a deployed state during which the hoist assembly 100 is used to hoist an object. The deployment can therefore transition the hoist assembly 100 from the storage state in which the hoist assembly 100 is folded to ensure no extension above the sidewalls 114 so that operator visibility remains completely unobscured, to the deployed state where full utility of the hoist assembly 100 can be achieved without any disassembly or reassembly.

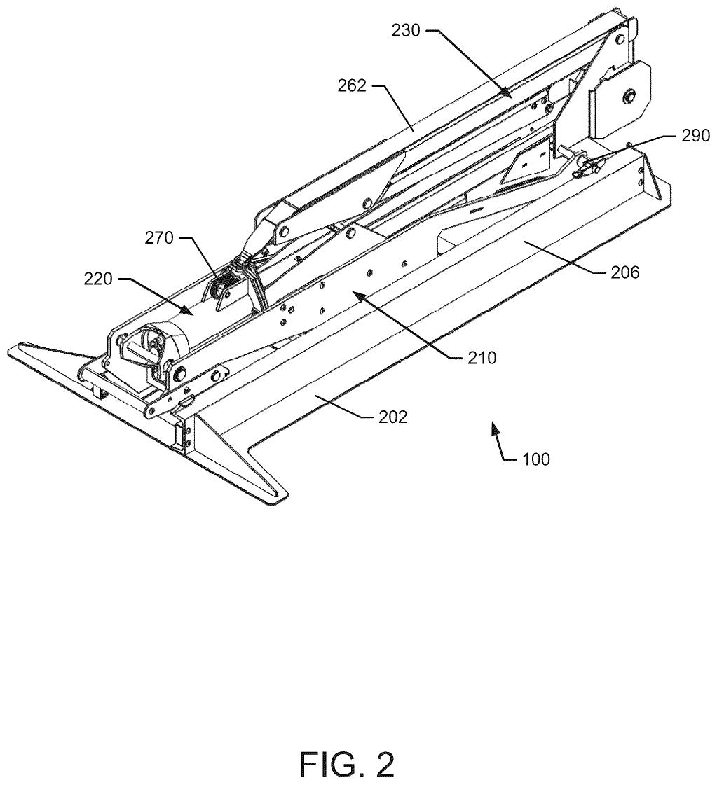

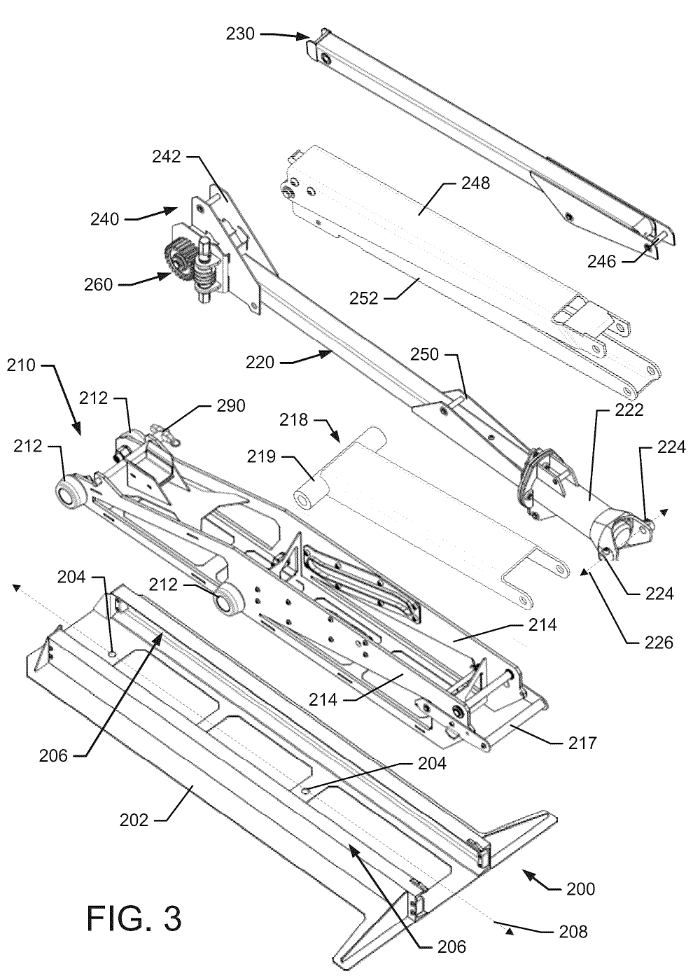

Turning to FIGS. 2 and 3, some major subassemblies or components of the hoist assembly 100 will be described in greater detail. In this regard, FIG. 2 shows a perspective view of the hoist assembly 100 in an assembled condition while in the storage state, and FIG. 3 shows a partially exploded view of various subassemblies or components of the hoist assembly 100. As shown in FIGS. 2 and 3, the hoist assembly 100 may include a base portion 200 and a carriage assembly 210 that is designed to be movable relative to the base portion 200, but otherwise be retained in slidable contact with the base portion 200 via a wheel or roller assembly that will be discussed in greater detail below.

The base portion 200 may include a mounting plate 202 that lies flat against the floor 112. The mounting plate 202 may include mounting holes 204 that may be spaced apart by sufficient distance to permit alignment with the floor openings 118. A set of retention grooves 206 may be formed on the mounting plate 202 to extend substantially parallel to a longitudinal axis 208 of the base portion 200. The retention grooves 206 of this example may be formed as C channels that extend along an entire length of the mounting plate 202 in the direction of the longitudinal axis 208 and are closed at each opposing longitudinal end thereof. Meanwhile the retention grooves 206 are open in the directions facing each other so that rollers 212 of the carriage assembly 210 can ride in the retention grooves 206 to reposition the carriage assembly 210 along the longitudinal axis 208. The rollers 212 are spaced apart from each other along the longitudinal axis 208 by a distance shorter than the length of the retention grooves 206 and the closure of the ends of the retention grooves 206 limits the range of motion of the rollers 212 accordingly.

The carriage assembly 210 may include a carriage body 214 that includes plate members defining sides of the carriage assembly 210 to which various other components may be attached. In this regard, for example, the carriage assembly 210 may be operably coupled to a first pivot arm 220 that pivots relative to the carriage assembly 210 to transition between the storage state and the deployed state. To accomplish the pivoting action, the first pivot arm 220 may connect to the carriage assembly 210 at one fixed pivot location, and at one variable support location. In an example embodiment, the first pivot arm 220 may include a tower casing 222, and the tower casing 222 may host components for connection forming both the fixed pivot location and the variable support location. In this regard, the tower casing 222 may include a set of pivot bosses 224 disposed opposite each other at a bottom end of the tower casing 222. The pivot bosses 224 may pivotally connect to opposite sidewalls of the carriage body 214 to define a first pivot axis 226 about which the tower casing 222 pivots to transition between the deployed state and the storage state. The variable support location is defined by a slide assembly 216 formed on internal sides of the carriage body 214 opposite each other and facing each other.

A slide brace 218 is attached (pivotally) to the tower casing 222 at one end thereof, and slidably fitted into the slide assembly 216 at the other end thereof. When the hoist assembly 100 is transitioned to the deployed state, a lower tube 219 of the slide brace 218 slides within the slide assembly 216 toward the pivot bosses 224. When the hoist assembly 100 is transitioned to the storage state, the lower tube 219 of the slide brace 218 slides away from the pivot bosses 224 and toward the rollers 212. In an example embodiment, either one or both opposite ends of the slide assembly 216 may include a detent aimed at retaining the lower tube 219 at either end of the slide assembly 216. The operator may apply a lifting force or lowering force to the first pivot arm 220 to urge the lower tube 219 past the detent at each opposing end of the slide assembly 216 to transition the hoist assembly 100 between the deployed state and the storage state. However, as will be discussed in greater detail below, further retention means may also be employed to hold the lower tube 219 in place in the deployed state (namely retention pin 290).

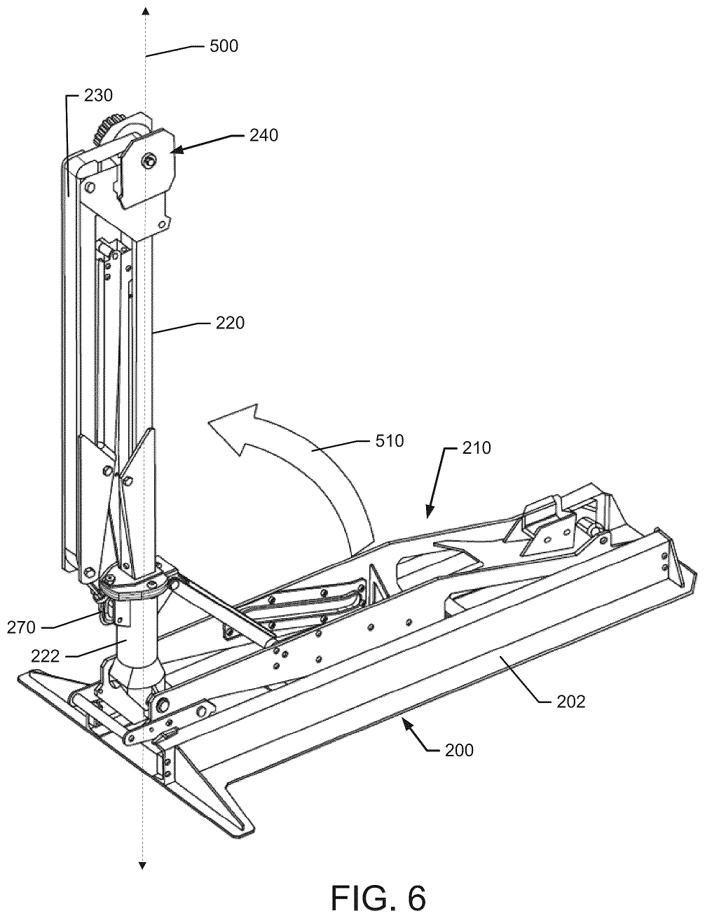

The carriage assembly 210 may also include a handle 217, which may be operably coupled to the carriage body 214. The handle 217 may be used to urge the carriage assembly 210 to slide out over the tail gate 116, or to urge the carriage assembly 210 to slide back toward the front of the vehicle to permit transition back to the storage state. The handle 217 may be used to slide the carriage assembly 210 either when the first pivot arm 220 is folded (e.g., to the position shown in FIGS. 1 and 2) or when the first pivot arm 220 is extended (e.g., in the position shown in FIGS. 6-10).

The first pivot arm 220 is operably coupled to the carriage assembly 210 at a first end thereof by the tower casing 222, as described above. The tower casing 222 may be considered to be a lower tower assembly by virtue of its position closest to the carriage assembly 210 when the first pivot arm 220 is oriented vertically or upright. The second end of the first pivot arm 220 is operably coupled to a second pivot arm 230 at an upper tower assembly 240, so named due to its being farther away from the carriage assembly 210 and above the lower tower assembly when the first pivot arm 220 is oriented vertically or upright. The upper tower assembly 240 may include a first plate assembly 242 providing a pivotal connection with a proximal end of the second pivot arm 230. The first plate assembly 242 may include a set of plates or brackets attached to opposite sides of a shaft portion 244 of the first pivot arm 220 to allow connection to other components. A pin, shaft, or other cylindrical component may pass through the first plate assembly 242 and the proximal end of the second pivot arm 230 to allow the second pivot arm 230 to pivot about the pin, shaft or other cylindrical component when transitioning between the deployed state and the storage state.

The second pivot arm 230 may also include a second plate assembly 246 that provides a pivotal connection with a first link arm 248 at a distal end of the second pivot arm 230. In this regard, the second plate assembly 246 may include a set of plates or brackets attached to opposite sides of the second pivot arm 230 to allow a pin, shaft, or other cylindrical component to pass through the second plate assembly 246 and the first link arm 248 to enable the first link arm 248 to pivot about the pin, shaft or other cylindrical component when transitioning between the deployed state and the storage state.

A third plate assembly 250 may be provided at the first pivot arm 220 proximate to the tower casing 222 to retain a pivotal connection with a second link arm 252 at the tower casing 222. The first and second link arms 248 and 252 may be pivotally attached to each other at ends thereof opposite the second pivot arm 230 and the first pivot arm 220 respectively to allow the first and second link arms 248 and 252 to fold relative to each other (and to both the first and second pivot arms 220 and 230 in the storage position shown in FIGS. 2 and 3). However, the first and second link arms 248 and 252 may be extended to align with each other between the second and third plate assemblies 246 and 250 to hold the second pivot arm 230 in the deployed state. When the first link arm 248 is extended relative to the second link arm 252, a latch assembly 251 may be employed to secure both the first and second link arms 248 to ensure that they stay in this position, even in the presence of a load being carried by the hoist assembly 100.

The upper tower assembly 240 may include a winch assembly 260, which may be attached to one plate of the first plate assembly 242. The winch assembly 260 may be operated to move a lifting member 262 (e.g., a strap, rope, chain or other flexible elongated member) to alternately lift or lower objects attached to the lifting member 262. In some cases, a distal end of the lifting member 262 may include a hook 270 or other attachment means that can engage the object that is to be lifted using the hoist assembly 100. The hook 270 may also be used, in some cases and if desired, as a latch or lock to the tower casing 222. In this regard, for example, the hook 270 may be attached to a portion of the tower casing 222 to lock the second pivot arm 230 to the first pivot arm 220 (e.g., as shown in FIG. 6) until deployment is desired.

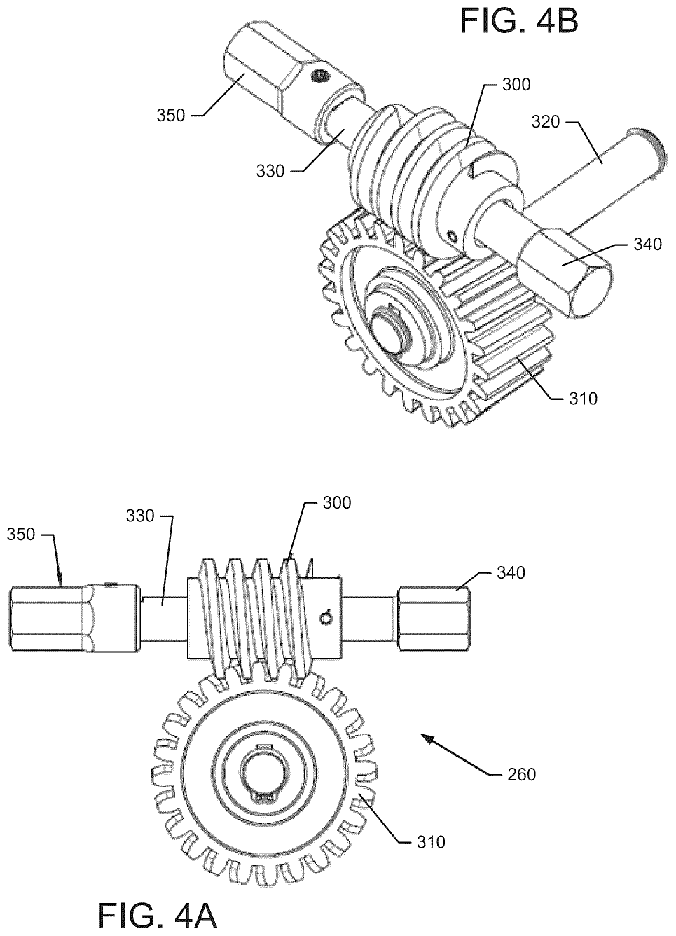

In an example embodiment, the winch assembly 260 may include a gear assembly including a drive gear 300 and a driven gear 310 that is operably coupled to an output shaft 320 that, when rotated either winds the lifting member 262 onto or off of a spool or reel assembly. The drive gear 300 is mounted on a drive shaft 330, as shown in FIGS. 4A and 4B. The drive shaft 330 of this example is double ended, in that the drive shaft 330 may include a first end 340 and a second end 350, each of which include a hex interface drivable via a hand crank or a power tool. The drive shaft 330 may extend substantially parallel to the floor 112 of the vehicle cargo bed 110 in the deployed state, but may be perpendicular to the floor 112 in the storage state (as shown in FIG. 1). Notably, the inclusion of the double ended drive shaft 330 may allow for convenient operation of the drive shaft 330 regardless of the orientation of the second pivot arm 230. In this regard, since the second pivot arm 230 may rotate 360 degrees, the positioning of the drive shaft 330 relative to the operator may be different in different scenarios, and may change during a given hoisting operation such that it may be convenient to switch between applying turning force to the drive shaft 330 via the first end 340 or the second end 350.

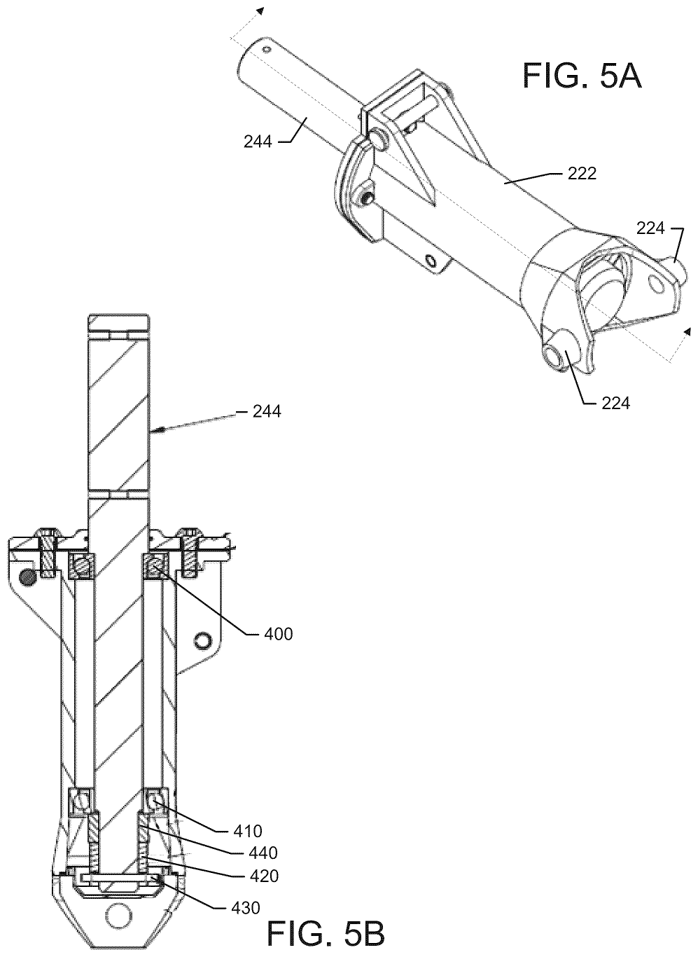

To enable the rotation of the second pivot arm 230, the first pivot arm 220 employs the tower casing 222 to house a first bearing assembly 400 and a second bearing assembly 410 that allow the shaft portion 244 to rotate 360 degrees within the tower casing 222. FIGS. 5A and 5B show a perspective view of the tower casing 222 and a cross section view through the tower casing 222, respectively. Meanwhile, the shaft portion 244 may be retained in the tower casing 222 by a castle nut 420 and cotter pin 430 separated from the second bearing assembly 410 by a spacer tube 440.

Operation of the hoist assembly 100 in transition from the storage state to the deployed state will now be discussed in reference to FIGS. 2, 3 and 6-10. As shown in FIG. 2, the retention pin 290 (which may also be referred to as a locking pin) may be used to affix the first pivot arm 220 to the carriage assembly 210. More particularly, in this example, the retention pin 290 may attach the carriage body 214 to the first plate assembly 242. By removing the retention pin 290, the first pivot arm 220 may be enabled to transition from the storage state, in which the first pivot arm 220 lies substantially parallel to the floor 112 (as shown in FIG. 1), to an upright condition shown in FIG. 6. This upright condition extends the first pivot arm 220 along a deployment axis 500 that is substantially perpendicular to the base portion 200. The transition may occur responsive to the operator pivoting the first pivot arm 220 about the pivot axis 226 of the tower casing 222 in the direction shown by arrow 510 in FIG. 6.

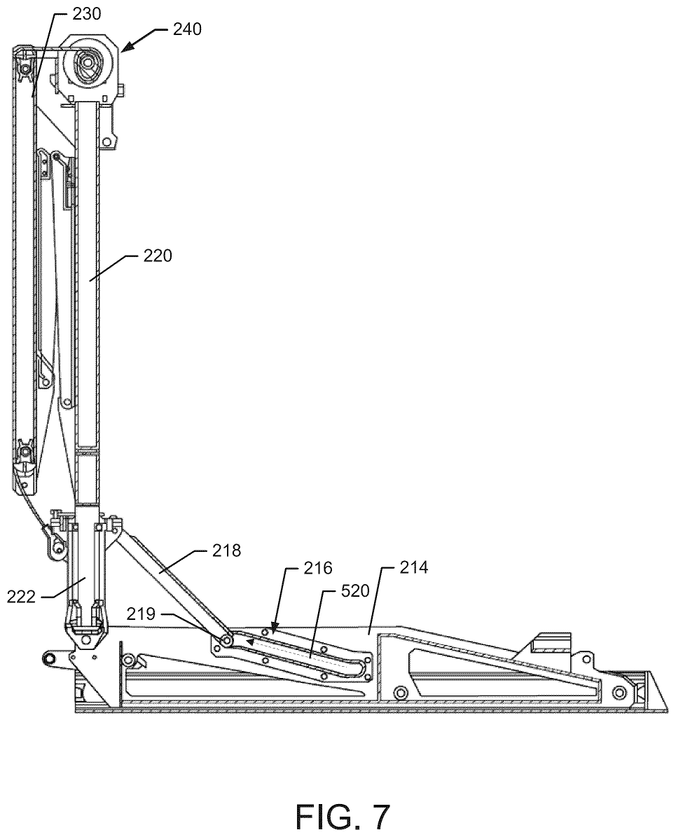

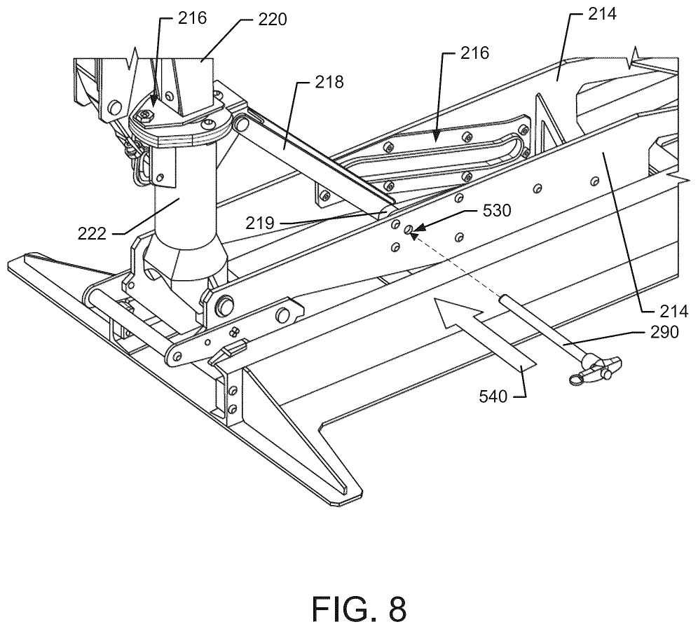

Referring now also to FIG. 7, the slide brace 218 moves through the slide assembly 216 in the direction of arrow 520 to reach the position shown in FIG. 7. At this stage, the second pivot arm 230 may remain parallel to the first pivot arm 220 (and the deployment axis 500), and substantially perpendicular to the base portion 200 and the floor 112. Thereafter, a locking orifice 530 formed in the carriage body 214 may be aligned with a central opening in the lower tube 219 of the slide brace 218 and the same pin (i.e., the locking pin 290) that locked the first pivot arm 220 in the storage state may be used to lock the first pivot arm 220 in the deployed state as shown in FIG. 8 due to insertion of the locking pin 290 in the direction of arrow 540.

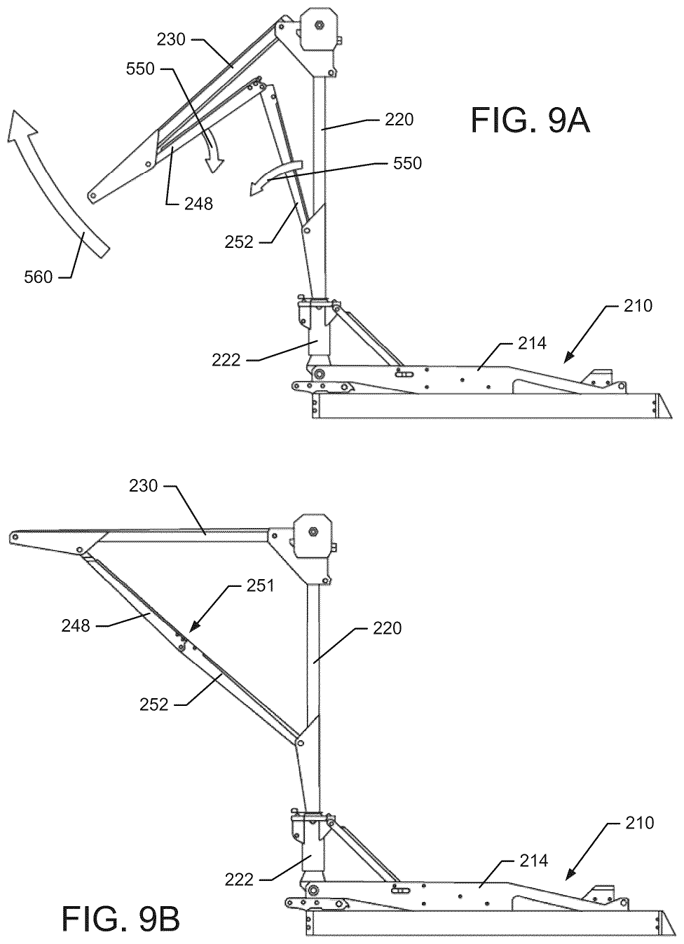

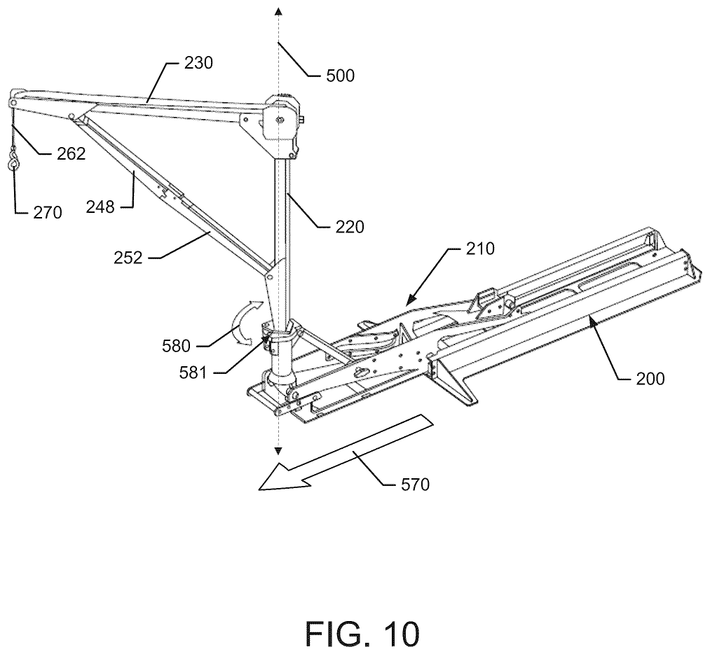

Thereafter, as shown in FIG. 9A, the first and second link arms 248 and 252 may be extended away from the second pivot arm 230 and the first pivot arm 220 (and each other) as shown by arrows 550. This pivoting begins to extend the second pivot arm 230 away from the first pivot arm 220 as shown by arrow 560. When the first and second link arms 248 and 252 are aligned with each other, and locked in such alignment, the second pivot arm 230 may be fully extended and ready for operation as shown in FIG. 9B. If desired (although not required), the carriage assembly 210 may be extended in the direction of arrow 570 shown in FIG. 10. The first and second bearing assemblies 400 and 410 of FIG. 5B may then allow the first pivot arm 220 to rotate 360 degrees about the deployment axis 500 in the directions of arrow 580 as shown in FIG. 10. However, it should be noted that hoisting operations may be conducted either with the carriage assembly 210 slid out over the tail gate 116, or without sliding the carriage assembly 210 at all. Moreover, the hoist assembly 100 could also be operated with the tail gate 116 closed. Stowage of the hoist assembly 100 may be conducted via a reversal of the operations outlined above. In some embodiments, the interface between the tower casing 222 and a lower portion of the first pivot arm 220 may employ one or more instances of a detent 581 or other rotation inhibitor, which may hold or assist in holding the first pivot arm 220 in a given position relative to the rotation about the deployment axis 500.

A hoist assembly for a vehicle cargo bed may be therefore be provided in accordance with an example embodiment. The hoist assembly may include a base portion operably coupled to a subframe of the vehicle in the vehicle cargo bed, a first pivot arm operably coupled to the base portion proximate a first end of the first pivot arm to pivot relative to the base portion between a deployed state and a storage state, a second pivot arm operably coupled to a second end the first pivot arm to pivot relative to the second end of the first pivot arm when transitioning between the deployed state and the storage state, and a carriage assembly operably coupling the first pivot arm to the base portion and enabling the first pivot arm to move relative to the base portion along a longitudinal axis of the base portion while the first pivot arm is in the deployed state.

The hoist assembly (or a vehicle including the same) of some embodiments may include additional features, modifications, augmentations and/or the like to achieve further objectives or enhance performance of the device. The additional features, modifications, augmentations and/or the like may be added in any combination with each other. Below is a list of various additional features, modifications, and augmentations that can each be added individually or in any combination with each other. For example, the carriage assembly may be entirely within the vehicle cargo bed in the storage state, and may enable the first pivot arm to slide over a portion of an extended tail gate in the deployed state. In an example embodiment, the first pivot arm may be substantially perpendicular to a floor of the vehicle cargo bed in the deployed state and substantially parallel to the floor in the storage state. In some cases, the base portion may attach to the subframe via a threaded fastener that extends through the floor of the vehicle cargo bed. In an example embodiment, the first pivot arm may include a lower tower assembly disposed at the first end of the first pivot arm. The lower tower assembly may include a tower casing comprising a pivot boss pivotally operably coupling the first pivot arm to the carriage assembly at a bottom end of the tower casing, and the tower casing may include a pivot bracket operably coupling a top end of the tower casing to a slide brace. The slide brace may slide within a slide assembly formed in the carriage assembly when transitioning between the deployed state and the storage state. In some cases, the tower casing may further include a bearing assembly enabling a tower shaft of the first pivot arm to rotate 360 degrees within the tower casing when the first pivot arm is in the deployed state. In an example embodiment, the first pivot arm may include an upper tower assembly disposed at the second end of the first pivot arm. The upper tower assembly may include a first plate assembly retaining a pivotal connection with a proximal end of the second pivot arm, and a second plate assembly retaining a pivotal connection with a first link arm at a distal end of the second pivot arm. A third plate assembly may retain a pivotal connection with a second link arm at the tower casing, and the first and second link arms may extend in alignment with each other between the second and third plate assemblies to hold the second pivot arm in the deployed state. In some cases, the upper tower assembly may operably couple a winch assembly to the hoist assembly to operate a lifting member to alternately lift or lower objects attached to the lifting member. In an example embodiment, the winch assembly may include a gear assembly operably coupled to a drive shaft, and the drive shaft may include a first end and a second end, each of which include a hex interface drivable via a hand crank or a power tool. In some cases, the drive shaft may extend substantially parallel to a floor of the vehicle cargo bed in the deployed state. In an example embodiment, a locking pin locks the upper tower assembly to the base portion in the storage state, and the locking pin locks the slide brace at a selected position of the slide assembly in the deployed state. In some cases, the first pivot arm may be locked in both the deployed state and the storage state by a same locking pin disposed at two different locking locations. In an example embodiment, the first pivot arm may extend higher than sidewalls of the vehicle cargo bed in the deployed state, and an entirety of the second pivot arm may be higher than the sidewalls in the deployed state. In this context, neither the first pivot arm nor the second pivot arm may extend higher than the sidewalls in the storage state. In some cases, the first and second pivot arms remain operably coupled to each other, and the first pivot arm remains operably coupled to the base portion via the carriage assembly during vehicle operation in the storage state. In an example embodiment, the first pivot arm may be extended along a deployment axis to be substantially perpendicular to the base portion in the deployed state and folded to be substantially parallel to the base portion in the storage state, and the first pivot arm may be both movable in a direction perpendicular to the deployment axis and rotatable about the deployment axis in the deployed state. In some cases, the base portion may include a pair of retention grooves, and the carriage assembly may include a set of rollers that ride within the retention grooves to carry the first pivot arm along the base portion in the deployed state.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A hoist assembly for a vehicle cargo bed, the hoist assembly comprising:
a base portion operably coupled to a subframe of the vehicle in the vehicle cargo bed;
a first pivot arm operably coupled to the base portion proximate a first end of the first pivot arm to pivot relative to the base portion between a deployed state and a storage state;
a second pivot arm operably coupled to a second end the first pivot arm to pivot relative to the second end of the first pivot arm when transitioning between the deployed state and the storage state; and
a carriage assembly operably coupling the first pivot arm to the base portion and enabling the first pivot arm to move relative to the base portion along a longitudinal axis of the base portion while the first pivot arm is in the deployed state.

2. The hoist assembly of claim 1, wherein the carriage assembly is entirely within the vehicle cargo bed in the storage state, and enables the first pivot arm to slide over a portion of an extended tail gate in the deployed state.

3. The hoist assembly of claim 1, wherein the first pivot arm is substantially perpendicular to a floor of the vehicle cargo bed in the deployed state and substantially parallel to the floor in the storage state.

4. The hoist assembly of claim 3, wherein the base portion attaches to the subframe via a threaded fastener that extends through the floor of the vehicle cargo bed.

5. The hoist assembly of claim 1, wherein the first pivot arm comprises a lower tower assembly disposed at the first end of the first pivot arm, the lower tower assembly comprising a tower casing comprising a pivot boss pivotally operably coupling the first pivot arm to the carriage assembly at a bottom end of the tower casing, and
wherein the tower casing comprises a pivot bracket operably coupling a top end of the tower casing to a slide brace, the slide brace sliding within a slide assembly formed in the carriage assembly when transitioning between the deployed state and the storage state.

6. The hoist assembly of claim 5, wherein the tower casing further comprises a bearing assembly enabling a tower shaft of the first pivot arm to rotate 360 degrees within the tower casing when the first pivot arm is in the deployed state.

7. The hoist assembly of claim 5, wherein the first pivot arm comprises an upper tower assembly disposed at the second end of the first pivot arm, the upper tower assembly comprising a first plate assembly retaining a pivotal connection with a proximal end of the second pivot arm, and a second plate assembly retaining a pivotal connection with a first link arm at a distal end of the second pivot arm,
wherein a third plate assembly retains a pivotal connection with a second link arm at the tower casing, and
wherein the first and second link arms extend in alignment with each other between the second and third plate assemblies to hold the second pivot arm in the deployed state.

8. The hoist assembly of claim 7, wherein the upper tower assembly operably couples a winch assembly to the hoist assembly to operate a lifting member to alternately lift or lower objects attached to the lifting member.

9. The hoist assembly of claim 8, wherein the winch assembly comprises a gear assembly operably coupled to a drive shaft, and
wherein the drive shaft comprises a first end and a second end, each of which include a hex interface drivable via a hand crank or a power tool.

10. The hoist assembly of claim 9, wherein the drive shaft extends substantially parallel to a floor of the vehicle cargo bed in the deployed state.

11. The hoist assembly of claim 7, wherein a locking pin locks the upper tower assembly to the base portion in the storage state, and
wherein the locking pin locks the slide brace at a selected position of the slide assembly in the deployed state.

12. The hoist assembly of claim 1, wherein the first pivot arm is locked in both the deployed state and the storage state by a same locking pin disposed at two different locking locations.

13. The hoist assembly of claim 1, wherein the first pivot arm extends higher than sidewalls of the vehicle cargo bed in the deployed state, and an entirety of the second pivot arm is higher than the sidewalls in the deployed state, and
wherein neither the first pivot arm nor the second pivot arm extends higher than the sidewalls in the storage state.

14. The hoist assembly of claim 1, wherein the first and second pivot arms remain operably coupled to each other, and the first pivot arm remains operably coupled to the base portion via the carriage assembly during vehicle operation in the storage state.

15. The hoist assembly of claim 1, wherein the first pivot arm is extended along a deployment axis to be substantially perpendicular to the base portion in the deployed state and folded to be substantially parallel to the base portion in the storage state, and
wherein the first pivot arm is both movable in a direction perpendicular to the deployment axis and rotatable about the deployment axis in the deployed state.

16. The hoist assembly of claim 1, wherein the base portion comprises a pair of retention grooves, and
wherein the carriage assembly comprises a set of rollers that ride within the retention grooves to carry the first pivot arm along the base portion in the deployed state.

17. A hoist assembly for a vehicle cargo bed, the hoist assembly comprising:
a base portion operably coupled to a subframe of the vehicle in the vehicle cargo bed;
a first pivot arm operably coupled to the base portion proximate a first end of the first pivot arm to pivot relative to the base portion between a deployed state and a storage state; and
a second pivot arm operably coupled to a second end the first pivot arm to pivot relative to the second end of the first pivot arm when transitioning between the deployed state and the storage state,
wherein the first pivot arm is extended along a deployment axis to be substantially perpendicular to the base portion in the deployed state and folded to be substantially parallel to the base portion in the storage state, and
wherein the first pivot arm is both moveable in a direction perpendicular to the deployment axis and rotatable about the deployment axis in the deployed state.

18. The hoist assembly of claim 17, further comprising a carriage assembly operably coupling the first pivot arm to the base portion to carry the first pivot arm while moving relative to the base portion in the direction perpendicular to the deployment axis.

19. The hoist assembly of claim 18, wherein the carriage assembly is entirely within the vehicle cargo bed in the storage state, and enables the first pivot arm to slide over a portion of an extended tail gate in the deployed state.

20. The hoist assembly of claim 17, wherein the base portion comprises a pair of retention grooves, and
wherein the carriage assembly comprises a set of rollers that ride within the retention grooves to carry the first pivot arm along the base portion in the deployed state.
